(19) United States
(12) Patent Application Publication
(10) Pub. No.: US 2012/0084034 A1
(43) Pub. Date: Apr. 5, 2012

(54) NON-TRANSITORY COMPUTER-READABLE MEDIUM STORING DESIGN CHECK PROGRAM, DESIGN CHECK APPARATUS, AND DESIGN CHECK METHOD

(75) Inventors: Yoshiaki Hiratsuka, Kawasaki (JP); Yoshihiro Sawada, Kawasaki (JP); Kenji Nagase, Kawasaki (JP); Tomoyuki Nakao, Kawasaki (JP); Keisuke Nakamura, Kawasaki (JP)

(73) Assignee: FUJITSU LIMITED, Kawasaki (JP)

(21) Appl. No.: 13/237,019

(22) Filed: Sep. 20, 2011

(30) Foreign Application Priority Data
Sep. 30, 2010 (JP) 2010-220207

(51) Int. Cl. G06F 19/00

(52) U.S. Cl. 702/65

(57) ABSTRACT

A design check method executed by a computer includes determining a countermeasure component provided in a certain range from a terminal of a reference component, determining whether a terminal of the determined countermeasure component is electrically connected to the terminal of the reference component, and determining that the countermeasure component is suitably mounted when the terminal of the determined countermeasure component that is electrically connected to the terminal of the reference component is at least within the certain range.

### CROSS-REFERENCE TO RELATED APPLICATIONS

This application is based upon and claims the benefit of priority of the prior Japanese Patent Application No. 2010-220207, filed on Sep. 30, 2010, the entire contents of which are incorporated herein by reference.

### FIELD

The embodiments discussed herein are related to a non-transitory computer-readable medium storing a design check program, a design check apparatus, and a design check method.

### BACKGROUND

In recent years, electro-magnetic interference (EMI) is checked based on design data prepared by computer-aided design (CAD). Japanese Laid-open Patent Publication No. 2006-155379 discusses a technology of executing a design check to suppress electromagnetic wave noise occurring in IT products or the like.

Mounting EMI-countermeasure components is one of the countermeasures to reduce EMI. Information about EMI-countermeasure components is disclosed by, for example, manufacturers of the EMI-countermeasure components. Designers determine what kind of EMI-countermeasure component should be selected for each net and determine the position of the EMI-countermeasure component, etc. based on the disclosed information about the EMI-countermeasure components.

FIG. 1 illustrates an exemplary check of EMI countermeasures in CAD data. In FIG. 1, the check is performed by tracing a net 3 from the terminal of a reference component 1 to find an EMI-countermeasure component 2. According to the check, whether or not the EMI-countermeasure component 2 is provided in the net 3 is confirmed, and then another EMI-countermeasure component is searched for by tracing another net.

In order to conform to international standards of CISPR 22, countermeasures are taken against EMI occurring during ordinary operations. Precision devices or apparatuses have been increasingly multifunctional, capable of high-frequency operations due to improved performance, and light-weighted. Consequently, it is difficult to use the casing of an apparatus as a shield against EMI. Therefore, countermeasures to reduce EMI of an apparatus should be considered at the time when designing a printed circuit board.

However, since each net is searched, much time is consumed on checking EMI countermeasures in CAD data, which is illustrated in FIG. 1.

### SUMMARY

According to an embodiment, a design check method executed by a computer includes determining a countermeasure component provided in a certain range from a terminal of a reference component, determining whether a terminal of the determined countermeasure component is electrically connected to the terminal of the reference component, and determining that the countermeasure component is suitably mounted when the terminal of the determined countermeasure component that is electrically connected to the terminal of the reference component is at least within the certain range.

The objects and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an exemplary check of EMI countermeasures in CAD data.

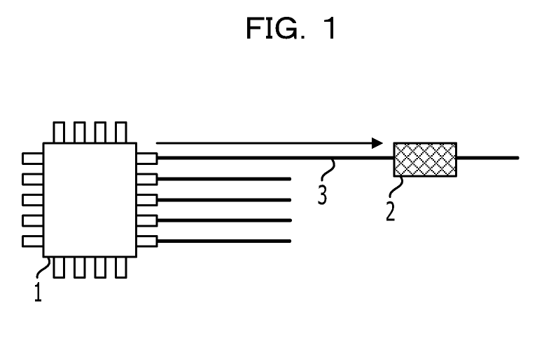

FIG. 2 illustrates a design check method according to an embodiment.

FIG. 3 illustrates how to calculate a countermeasure-component search range.

FIG. 4 illustrates a hardware configuration of a computer executing an embodiment.

FIG. 5 illustrates a block configuration of a design check apparatus according to an embodiment.

FIG. 6 illustrates a structure of a netlist table.

FIG. 7 illustrates a structure of a pin table.

FIG. 8 illustrates a structure of a via table.

FIG. 9 illustrates a structure of a component table.

FIG. 10 illustrates a structure of a countermeasure-component library table.

FIG. 11 illustrates a process performed by a design check apparatus.

FIG. 12 illustrates an image of a process in FIG. 11.

FIG. 13 illustrates a block configuration according to another embodiment.

FIG. 14 illustrates an exemplary modification of a countermeasure-component library table.

FIG. 15 illustrates other processing operations performed by a design check apparatus.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

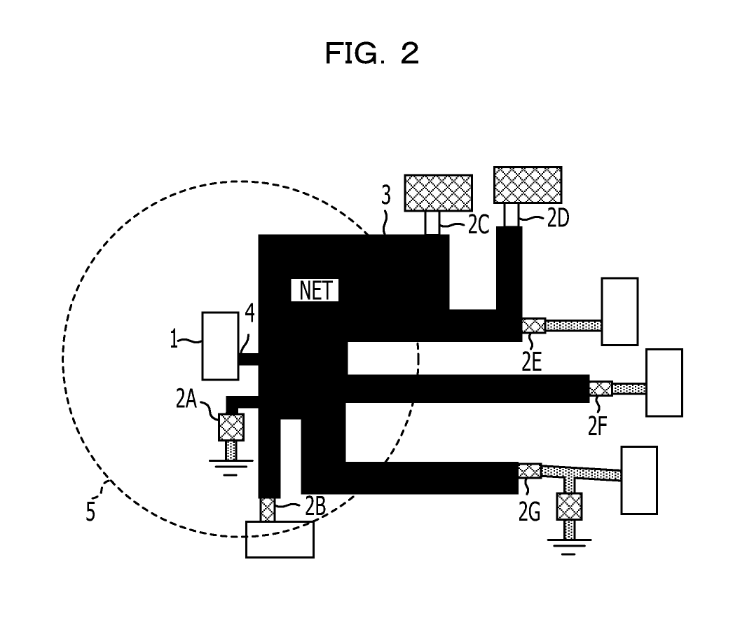

FIG. 2 illustrates an image illustrating a design check method according to an embodiment. FIG. 2 illustrates a component 1 provided as a reference (hereinafter referred to as the reference component 1), a net 3 which is electrically connected to a pin (PIN) 4 which is a terminal of the reference component 1, and EMI-countermeasure components (hereinafter referred to as the countermeasure components) 2A, 2B, 2C, 2D, 2E and 2G (2A to 2G) that are mounted on the net 3.

A net provided at a position beyond the countermeasure components 2A, and 2E to 2G with reference to the pin 4 is different from the net 3. In the check of EMI countermeasures conventionally performed in CAD data, the check was started from the pin 4 of the reference component 1 and performed along the net 3 to search for the EMI countermeasure components 2A to 2G. In other words, each of the countermeasure components 2A to 2G mounted on the net 3 was checked in the past. Consequently, when the net 3 has a complicated structure, it is difficult to execute the check of the EMI countermeasures in the CAD data, causing the man-hours to increase (requiring much time).

Therefore, according to the design check method of an embodiment, first, a countermeasure-component search range 5 centering on the pin 4 of the reference component 1 is searched for countermeasure components that are included therein. In FIG. 2, the countermeasure-component search range 5 is searched to thereby find the countermeasure components 2A and 2B that are included therein, for example.

Subsequently, according to the design check method of an embodiment, when any of the found countermeasure components is connected to the same net as the pin 4 of the reference component 1 is connected to, it is determined that the countermeasure component is mounted at an appropriate position (the countermeasure component is appropriately mounted). FIG. 2 illustrates that the net 3, to which the pin 4 is connected, is connected to the countermeasure components 2A and 2B, and therefore it is determined that the countermeasure components 2A and 2B are mounted at appropriate positions.

The process of searching the countermeasure-component search range 5 centering on the pin 4 of the reference component 1 for the countermeasure component included therein is a process of searching for a countermeasure component within a certain linear distance from the pin 4 of the reference component 1. The method of calculating the countermeasure-component search range 5 is described below in detail. According to the design check method of an embodiment, the countermeasure-component search range 5 is searched for the countermeasure components 2A and 2B that are included therein. Consequently, the search range is narrowed down, and all the countermeasure components 2A to 2G that are mounted on the net 3 may not be necessarily checked.

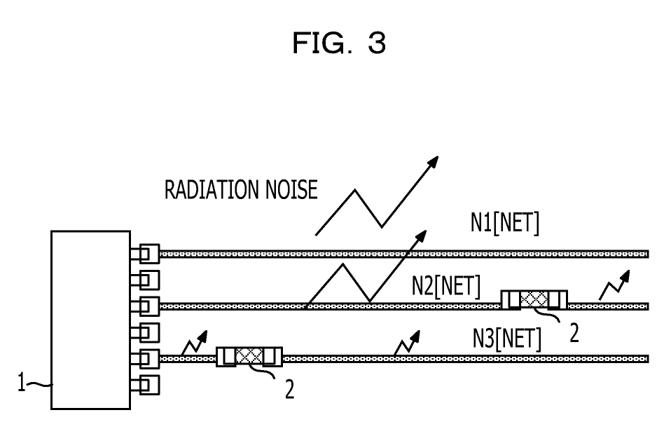

FIG. 3 illustrates an image illustrating the method of calculating a countermeasure-component search range. The distance between a pin of the reference component 1 and a countermeasure component 2 is usually calculated as below. First, a relationship between a radiation noise and the countermeasure component 2 is described.

The countermeasure component 2 is not mounted on a net N1 illustrated in FIG. 3. Although the countermeasure component 2 is mounted on a net N2 illustrated in FIG. 3, there is a large distance between a pin of the reference component 1 and the countermeasure component 2. The countermeasure component 2 is mounted on a net N3 illustrated in FIG. 3 considerably near a pin of the reference component 1.

Since the countermeasure component 2 is not mounted on the net N1 and the net N1 serves as a noise-radiating antenna, the radiation noise of the net N1 is increased. After the countermeasure component 2 is mounted on the net N2, the radiation noise of the net N2 is decreased. However, since there is a large distance between the reference component 1 and the countermeasure component 2 provided on the net N2, and part of the net N2, the part extending between the reference component 1 and the countermeasure component 2, serves as a noise-radiation antenna, the radiation noise of the net N2 is increased.

Accordingly, it is effective to mount the countermeasure component 2 on the net N3 as near the pin of the reference component 1 as possible. In FIG. 3, the radiation noise is decreased in the order of the nets N1, N2, and N3.

The countermeasure-component search range 5 is determined in consideration of a limitation imposed when the countermeasure component 2 is actually mounted (e.g., a condition for manufacturing a mounter), that is, has at least several millimeters and a length which prevents the net from being the noise-radiation antenna. Here, the length which prevents the net from being the antenna is related to the frequency of radiation noise to be suppressed. The frequency is stated in CISPR standards, which are international regulations usually used.

Although conditions are varied among target apparatuses, other frequencies may also be suppressed by calculating the countermeasure-component search range 5 of currently available information technology equipment (ITE) on one side of the range of from 150 kHz to 6 GHz, where a wavelength 2 attained on the one side is shorter than that attained on the other side. In an embodiment, therefore, the frequency is exemplarily determined to be 6 GHz to calculate the length of the countermeasure-component search range 5. The speed of light is expressed as 3×10⁸ (m/s).

The wavelength λ (m)=the light speed (m/s)÷frequency (Hz) (1)

The length which decreases the antenna efficiency should be less than (¼)λ. When the above-described conditions are applied to Equation (1), the wavelength λ (m) is expressed by the equation such that 3×10⁸ (m/s)÷6×10⁹ (Hz)=0.05 m. It is preferable that the distance where the countermeasure component 2 is mounted be less than 0.0125 m=0.05 (m)÷4, which leads to the conclusion that the countermeasure-component search range 5 where the countermeasure component 2 is mounted is several mm to less than 12.5 mm. Without being limited to the above-described exemplary method, another method may be used to calculate the countermeasure-component search range 5. While specific examples of calculating a range, the present invention is not limited to these calculations and may calculate a range relative to condition(s) affecting performance of an apparatus.

A non-transitory computer-readable medium storing a design check program, a design check apparatus, and a design check method of the embodiments are exemplarily provided, and a program stored in a medium, an apparatus, and a method having different names may be provided.

For example, the design check method of the embodiment may be achieved by a function of CAD, or a tool including a viewer, etc., which is different from CAD. The design check program of an embodiment may be executed by a single personal computer or server computer, or a plurality of personal computers or server computers for distributed processing. Hereinafter, the personal computer and the server computer are collectively referred to as PCs.

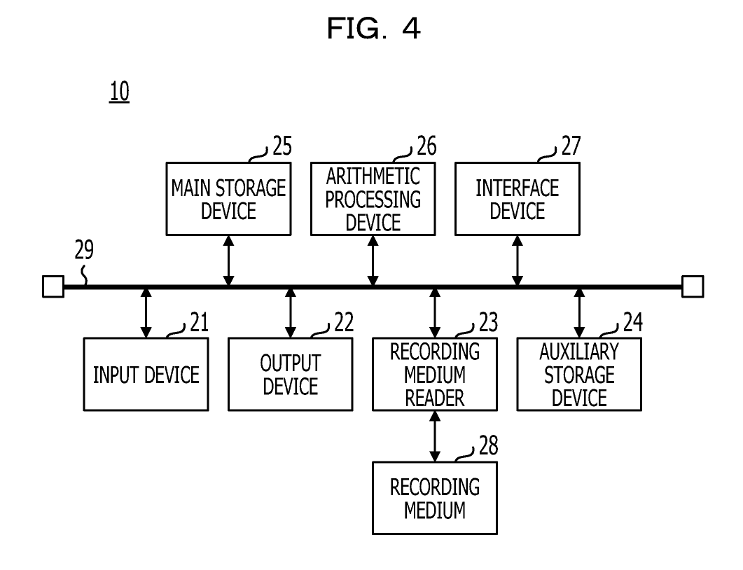

A PC executing the design check program of the embodiment includes hardware configuration illustrated in FIG. 4, for example. FIG. 4 illustrates a hardware configuration of an exemplary PC 10.

The PC 10 includes an input device 21, an output device 22, a recording medium reader 23, an auxiliary storage device 24, a main storage device 25, an arithmetic processing device 26, and an interface device 27 that are connected to one another via a bus 29.

The input device 21 includes a keyboard, a mouse, etc., and is used to input various signals. The output device 22 includes a display device or the like, and is used to display various windows, data, and so forth. The interface device 27 includes a modem, a LAN card, etc., and is used to connect the PC 10 to a network.

The design check program stored in the medium of the embodiment is at least part of various programs controlling the PC 10 illustrated in FIG. 4. The design check program is provided through the distribution of a recording medium 28 or downloaded from a network.

The recording medium 28 recording the design check program includes various types of recording media. For example, the recording medium 28 may be a CD-ROM, a flexible disk, a magneto-optical disk, etc., in which information is recorded optically, electrically, or magnetically. Further, the recording medium 28 may be a semiconductor memory including a ROM, a flash memory, etc., in which information is electrically recorded.

When the recording medium 28 storing the design check program is set into the recording medium reader 23, the design check program is installed from the recording medium 28 into the auxiliary storage device 24 via the recording medium reader 23. When being downloaded from a network, the design check program is installed in the auxiliary storage device 24 via the interface device 27. The auxiliary storage device 24 stores therein files, data, etc., in addition to the installed design check program. When starting the design check program, the main storage device 25 reads the design check program from the auxiliary storage device 24 and stores therein the design check program. The arithmetic processing device 26 executes various types of processing that will be described later based on the design check program stored in the main storage device 25. The PC 10 executing the design check program is an example of the design check apparatus.

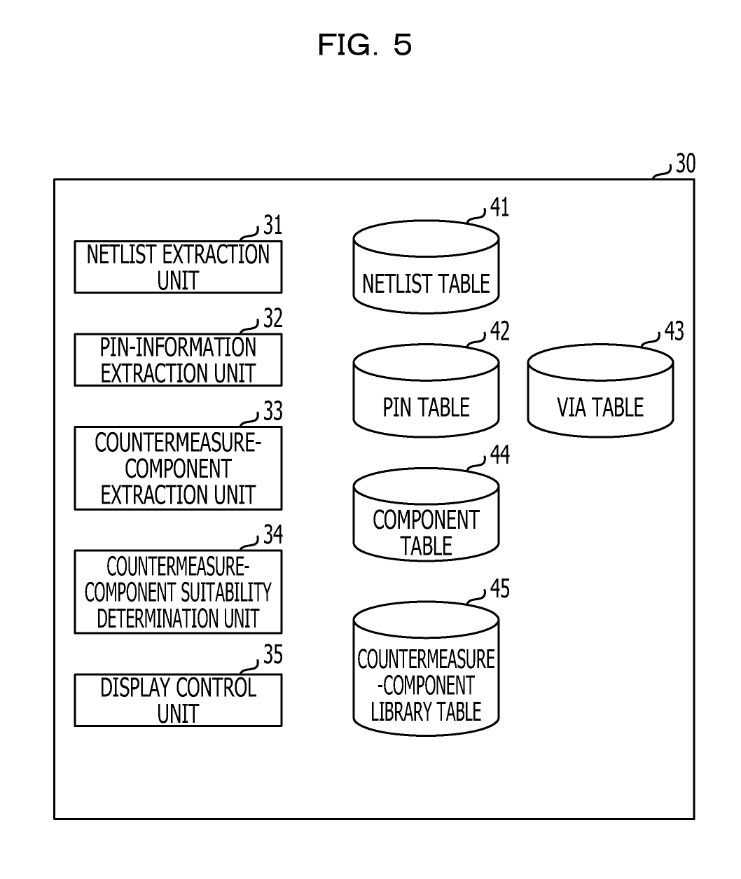

For example, the PC 10 executes various types of processing illustrated in FIG. 5 based on the design check program stored in the main storage device 25. FIG. 5 illustrates a block configuration of an exemplary design check apparatus according to an embodiment.

The design check apparatus 30 includes a netlist extraction unit 31, a pin-information extraction unit 32, a countermeasure-component extraction unit 33, a countermeasure-component suitability determination unit 34, a display control unit 35, a netlist table 41, a pin table 42, a via table 43, a component table 44, and a countermeasure-component library table 45. Each of the blocks that are illustrated in FIG. 5 may be provided as software, or part of the blocks may be provided as hardware.

The netlist extraction unit 31 extracts a target net from the netlist table 41. The pin-information extraction unit 32 identifies a pin (driver) of the target net in the netlist table 41. The pin-information extraction unit 32 extracts the center coordinates of the pin (driver) of the target net from the pin table 42.

The countermeasure-component extraction unit 33 extracts components that are mounted in a countermeasure-component search range from the component table 44. The countermeasure-component search range may be calculated as described above and stored in the auxiliary storage device 24, for example. The countermeasure-component extraction unit 33 extracts components that are connected to the target net from the extracted components that are mounted in the countermeasure-component search range. Further, the countermeasure-component extraction unit 33 extracts the countermeasure component from the extracted components that are connected to the target net.

The countermeasure-component suitability determination unit 34 references the countermeasure-component library table 45 and determines whether or not the extracted countermeasure component is suitable in view of the class of the target net. The display control unit 35 displays the processing result on the output device 22 or the like.

The netlist table 41 is a record unit to record therein a netlist. The pin table 42 is a record unit to record therein pin information. The via table 43 is a record unit to record therein via information. The component table 44 is a record unit to record therein component information. The countermeasure-component library table 45 is a record unit to record therein the class of a suitable countermeasure component for each net.

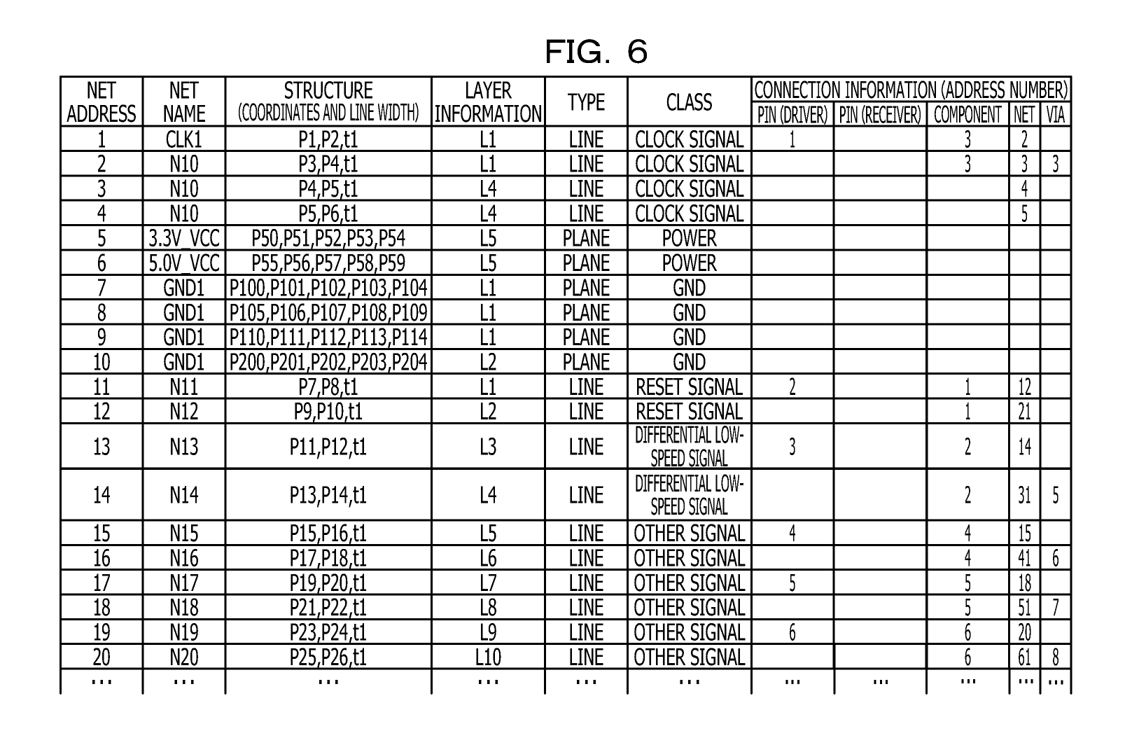

FIG. 6 illustrates a structure of an exemplary netlist table. The netlist table 41 in FIG. 6 includes as items thereof “net address”, “net name”, “structure (coordinates and line width)”, “layer information”, “type”, “class”, and “connection information”. The item “type” in FIG. 6 indicates the form of a net, which is expressed as a line, plane, etc. The item “class” in FIG. 6 indicates the class of a signal flowing through a net.

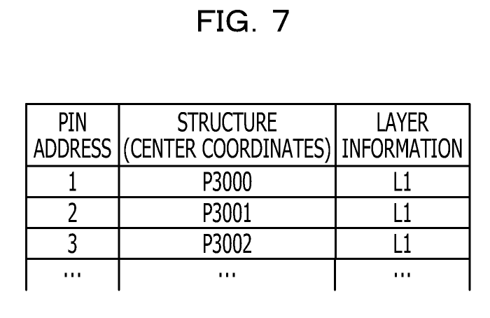

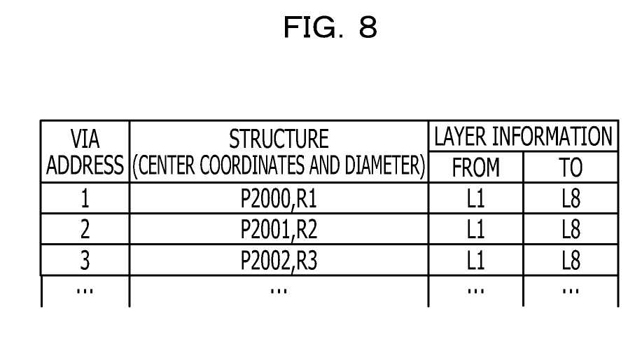

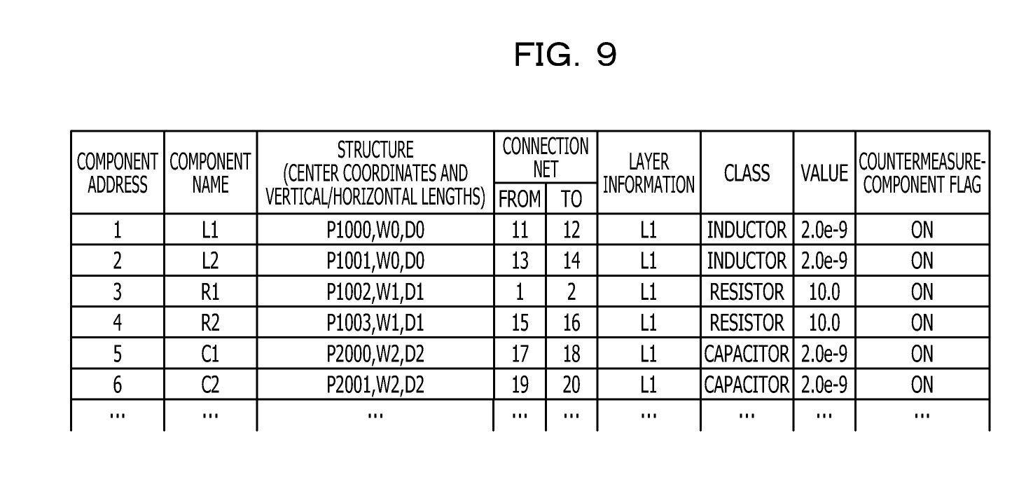

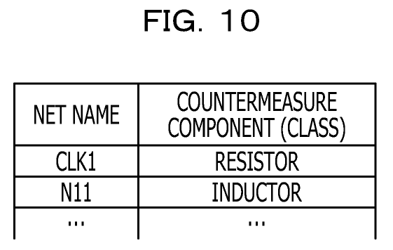

FIG. 7 illustrates a structure of an exemplary pin table. The pin table 42 in FIG. 7 includes as items thereof “pin address”, “structure (center coordinates)”, and “layer information”. FIG. 8 illustrates a structure of an exemplary via table. The via table 43 in FIG. 8 includes as items thereof “via address”, “structure (center coordinates and diameter)”, and “layer information”. FIG. 9 illustrates a structure of an exemplary component table. The component table 44 in FIG. 9 includes as items thereof “component address”, “component name”, “structure (center coordinates and vertical/horizontal lengths)”, “connection net”, “layer information”, “class”, “value”, and “countermeasure-component flag”. The item “class” in FIG. 9 indicates a class of a component such as an inductor, resistor, capacitor, etc. FIG. 10 illustrates a structure of an exemplary countermeasure-component library table. A countermeasure-component library table 45 in FIG. 10 includes as items thereof “net name”, and “countermeasure component (class)”.

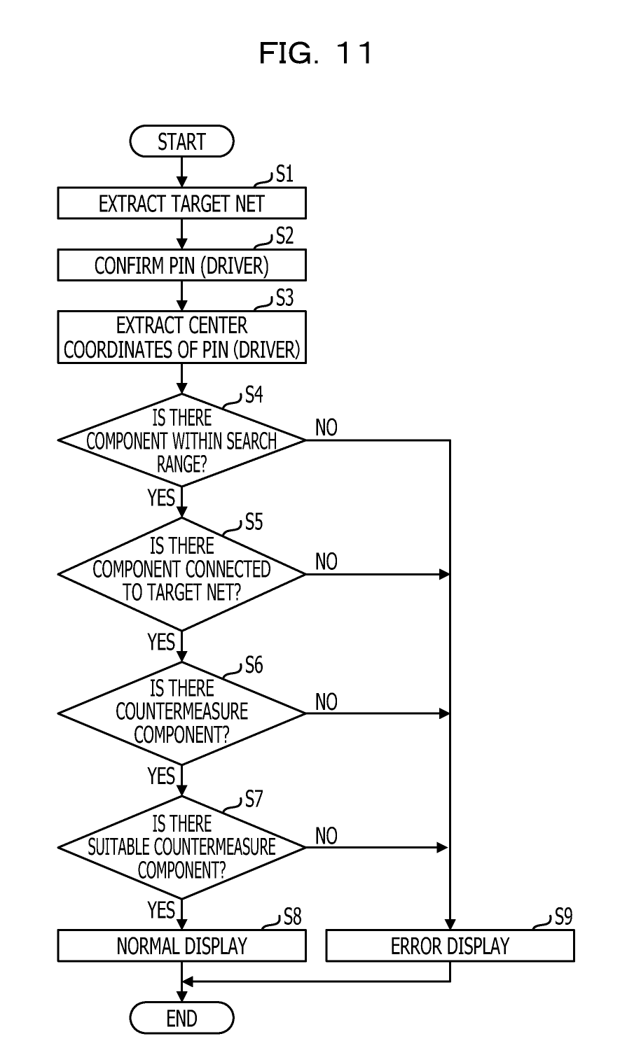

FIG. 11 is an exemplary flowchart illustrating operations of a process that is performed by the design check apparatus. When the processing advances to operation S1, the netlist extraction unit 31 searches the netlist table 41 based on, for example, “net name” as a key, and extracts the netlist of a target net. According to the example of FIG. 6, the netlist extraction unit 31 searches the netlist table 41 based on a net name “CLK1” as a key, and extracts the netlist corresponding to a net address “1”. When the processing advances to operation S2, the pin-information extraction unit 32 refers to the netlist of the target net, which is extracted at operation S1, and confirms the address number (pin address) of a pin (driver) included in the connection information of the netlist. According to the example of FIG. 6, the pin-information extraction unit 32 confirms an address number “1” as pin address, the address number “1” being included in the connection information of the netlist corresponding to the net address “1”.

When the processing advances to operation S3, the pin-information extraction unit 32 acquires from the pin table 42 the pin information corresponding to the pin address confirmed at operation S2, and extracts structure (center coordinates) included in the acquired pin information. The structure (center coordinates) extracted at operation S3 represents the center coordinates of the countermeasure-component search range. According to the example of FIG. 7, the pin-information extraction unit 32 extracts center coordinates “P3000” corresponding to the pin address “1”.

When the processing advances to operation S4, the countermeasure-component extraction unit 33 extracts a component mounted in the countermeasure-component search range from the component table 44. More specifically, the countermeasure-component extraction unit 33 acquires information about a component from the component table 44, and extracts structure (center coordinates) included in the acquired component information. The countermeasure-component extraction unit 33 determines whether or not the component is mounted in the countermeasure-component search range based on the distance between the center coordinates of the countermeasure-component search range and those of the component. According to the example of FIG. 9, it is determined whether or not a component is mounted in the countermeasure-component search range based on the distance between the center coordinates “P3000” and center coordinates “P1000”, “P1001”, and so forth that are included in structure of the component information.

When there are components that are mounted in the countermeasure-component search range, the countermeasure-component extraction unit 33 advances to operation S5, and extracts a component connected to the target net from the mounted components. More specifically, the countermeasure-component extraction unit 33 extracts a component connected to the target net by searching for connection net of the component information of a component that is mounted in the countermeasure-component search range based on “net address” of the target net extracted at operation S1 as a key. Connection net of the component information includes the net address of the net to which the component is connected.

According to the example of FIG. 9, the countermeasure-component extraction unit 33 searches for connection net of the component information of a component that is mounted in the countermeasure-component search range based on the net address “1” as a key, so that the component corresponding to a component address “3”, which is connected to the target net, is extracted.

When there are components that are mounted in the countermeasure-component search range and connected to the target net, the countermeasure-component extraction unit 33 advances to operation S6, and extracts the countermeasure components from the components that are extracted at operation S5. More specifically, the countermeasure-component extraction unit 33 determines whether or not the components are the countermeasure components by referring to the countermeasure-component flag included in the component information. According to the example of FIG. 9, the countermeasure-component flag corresponding to the component of the component address “3” indicates “ON”, the component is extracted as the countermeasure component.

When there is a component that is mounted in the countermeasure-component search range and connected to the target net, the countermeasure-component suitability determination unit 34 advances to operation S7, and determines whether or not the countermeasure component extracted at operation S6 is suitable. More specifically, the countermeasure-component suitability determination unit 34 refers to the countermeasure-component library table 45, and when the class of the suitable countermeasure component of the target net agrees with that included in the component information of the countermeasure component extracted at operation S6, the countermeasure-component suitability determination unit 34 determines that the countermeasure component extracted at operation S6 is a suitable countermeasure component. According to the example of FIG. 10, the countermeasure-component suitability determination unit 34 searches the countermeasure-component library table 45 based on the net name “CLK1” as a key. Since a class “Resistor” of a suitable countermeasure component of the target net agrees with a class “Resistor” of the component corresponding to the component address “3”, the countermeasure-component suitability determination unit 34 determines that the component is a suitable countermeasure component. When the component is determined to be the suitable countermeasure component at operation S7, the display control unit 35 advances to operation S8, and displays data indicating that the countermeasure component is suitably mounted in the target net.

When it is determined that no component is mounted in the countermeasure-component search range at operation S4, that no component is connected to the target net at operation S5, that there is no countermeasure component at operation S6, or that there is no suitable countermeasure component at operation S7, the display control unit 35 advances to operation S9 and executes an error display.

The error display may include information about the class of the countermeasure component suitable for the target net. Although a flowchart of FIG. 11 illustrates an example where a normal display or an error display is executed for each target net, the normal display or the error display may be executed after a plurality of nets is processed.

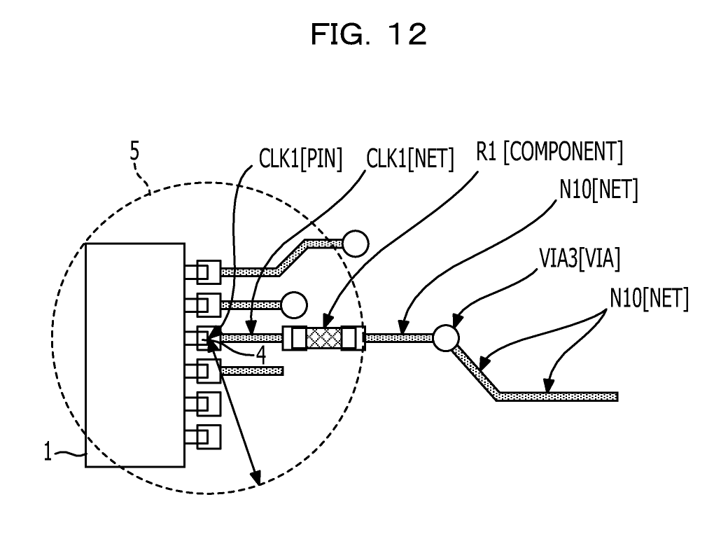

FIG. 12 illustrates an exemplary image of a process of the flowchart of FIG. 11. The netlist extraction unit 31 searches the netlist table 41 based on a net name “CLK1” as a key, and extracts the netlist of a net address “1” as the netlist of the target net.

The pin-information extraction unit 32 refers to the netlist of the net address “1”, and confirms an address number “1” of the pin (driver) included in connection information. The pin-information extraction unit 32 acquires pin information having the address number “1” as a pin address from the pin table 42. The pin-information extraction unit 32 refers to structure (center coordinates) included in the acquired pin information, and extracts center coordinates “P3000” which become the center coordinates of the countermeasure-component search range 5.

The countermeasure-component extraction unit 33 extracts a component “R1” mounted in the countermeasure-component search range 5 based on the distance between center coordinates “P3000” of the countermeasure-component search range 5 and center coordinates “P1002” of the component “R1” that is stored in the component table 44.

Since the net address “1” is included in connection net of component information of the component “R1” mounted in the countermeasure-component search range 5, the countermeasure-component extraction unit 33 determines that the component “R1” is connected to the target net.

The countermeasure-component extraction unit 33 determines whether or not the component “R1” which is mounted in the countermeasure-component search range 5 and connected to the target net is the countermeasure component based on countermeasure-component flag of component information of the component “R1”. According to the component information illustrated in FIG. 9, the countermeasure-component flag corresponding to the component “R1” indicates “ON”, which indicates that the component “R1” is the countermeasure component.

The countermeasure-component suitability determination unit 34 further refers to the countermeasure-component library table 45 and acquires a class “Resistor” of a countermeasure component suitable for the target net based on the net name “CLK1” as a key. Since the class “Resistor” of the component “R1” agrees with the class “Resistor” of the countermeasure component suitable for the target net, which is acquired from the countermeasure-component library table 45, the countermeasure-component suitability determination unit 34 determines that the component “R1” is the suitable countermeasure component.

As described above, according to an embodiment, whether or not the position and class of a countermeasure component are suitable is automatically and correctly determined at a high speed for each net which may need measures against EMI on a printed circuit board. Accordingly, whether or not the countermeasure component is suitably mounted is readily determined.

In an embodiment, whether or not a countermeasure component is suitably mounted is determined by determining whether or not a suitable countermeasure component is mounted in a countermeasure-component search range. According to an embodiment, whether or not the countermeasure component is suitably mounted is determined more accurately by considering a distance between the center coordinates (pin) of the countermeasure-component search range and the countermeasure component measured along the net form, in addition to considering the conditions of an embodiment. This embodiment is only partly different from the above-described embodiment, and therefore, the same part as that of the above-described embodiment will not be described as appropriate.

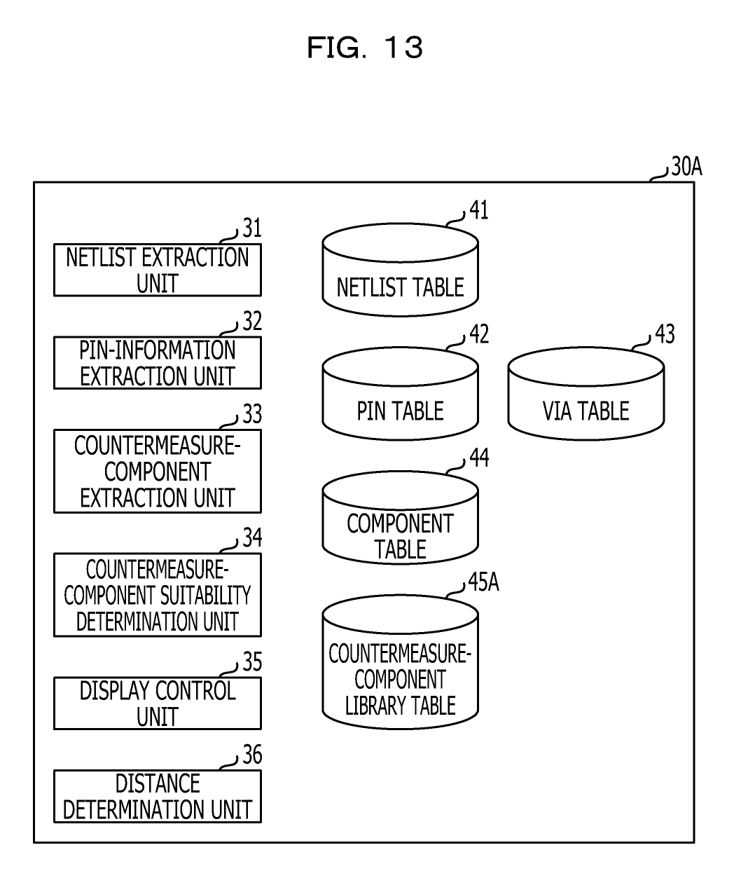

FIG. 13 illustrates a block configuration of another exemplary design check apparatus 30A according to an embodiment. The design check apparatus 30A illustrated in FIG. 13 includes a distance determination unit 36 in addition to the units of the design check apparatus 30 illustrated in FIG. 5. The distance determination unit 36 calculates the distance between the center coordinates of the countermeasure-component search range and the countermeasure component measured along the net form, and determines whether or not the value of the calculated distance is within a threshold, which is set for each net. Each of the blocks that are illustrated in FIG. 13 may be provided as software, or part of the blocks may be provided as hardware.

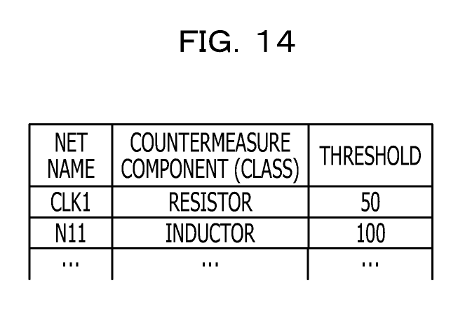

The threshold is set for each net in a countermeasure-component library table 45A illustrated in FIG. 14, for example. FIG. 14 illustrates another exemplary structure of the countermeasure-component library table 45 illustrated in FIG. 10. In addition to the items of the countermeasure-component library table 45, the countermeasure-component library table 45A illustrated in FIG. 14 includes “threshold” as an item thereof. The item “threshold” indicates the threshold of the distance. It is preferable that the value of the distance between the center coordinates of the countermeasure-component search range and the countermeasure component measured along the net form be within the threshold in the item.

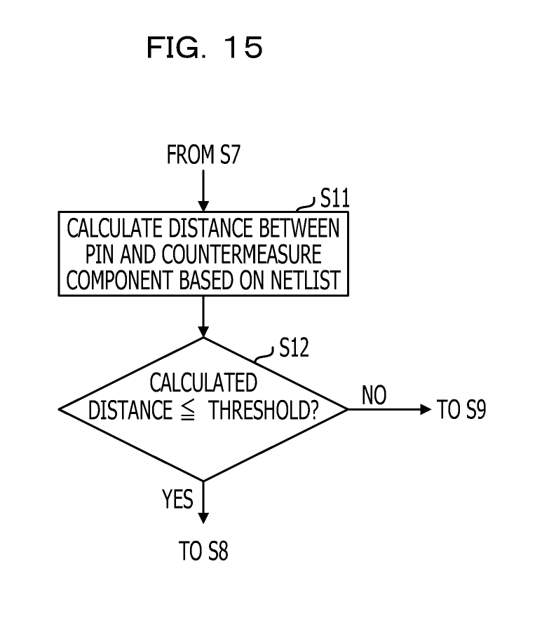

FIG. 15 is another exemplary flowchart illustrating operations of a process that is performed by the design check apparatus. In addition to the processing of the flowchart of FIG. 11, the flowchart of FIG. 15 includes operations S11 and S12.

When it is determined that the countermeasure component is suitable at operation S7 of FIG. 11, the distance determination unit 36 advances to operation S11 and calculates the distance between the pin (the center coordinates of the countermeasure-component search range) and the countermeasure component. More specifically, the distance determination unit 36 refers to the netlist table 41 and traces the connections so that the distance between the center coordinates of the countermeasure-component search range and the countermeasure component measured along the net form is calculated.

When the processing advances to operation S12, the distance determination unit 36 refers to the countermeasure-component library table 45A of FIG. 14, and acquires the threshold of the distance of the target net. The distance determination unit 36 determines whether or not the value of the distance calculated at operation S11 is within the threshold, which is acquired from the countermeasure-component library table 45A of FIG. 14.

When the value of the distance calculated at operation S11 is within the threshold, the threshold being acquired from the countermeasure-component library table 45A of FIG. 14, the display control unit 35 advances to operation S8 of FIG. 11. When the value of the distance calculated at operation S11 is greater than the threshold, the threshold being acquired from the countermeasure-component library table 45A of FIG. 14, the display control unit 35 advances to operation S9 of FIG. 11.

According to an embodiment, it is determined that the countermeasure component is suitably mounted more accurately by considering the distance between the center coordinates of the countermeasure-component search range and the countermeasure component measured along the net form, in addition to considering the conditions of the above-described embodiment.

As mentioned above, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiments of the present inventions have been described in detail, it should be understood that various changes, substitutions, and alterations could be made hereto without departing from the spirit and scope of the invention, the scope of which is defined in the claims and their equivalents.

What is claimed is:

1. A non-transitory computer-readable medium storing a design check program, which when executed by a computer, causes the computer to execute an operation, comprising:
determining, based on design data, a countermeasure component provided in a certain range from a terminal of a reference component;
determining, based on the design data, whether a terminal of the determined countermeasure component is electrically connected to the terminal of the reference component; and
determining that the countermeasure component is suitably mounted when the terminal of the determined countermeasure component that is electrically connected to the terminal of the reference component is at least within the certain range.

2. The non-transitory computer-readable medium according to claim 1, which causes the computer to execute:
referring to a storage unit storing a net connected to the terminal of the reference component and a class of the countermeasure component of the net, the net and the class being associated with each other, and
determining that the countermeasure component is suitably mounted when the class of the countermeasure component which is electrically connected to the terminal of the reference component is stored in the storage unit as the class of the countermeasure component of the net connected to the terminal of the reference component.

3. The non-transitory computer-readable medium according to claim 1, wherein the determining of whether the terminal of the determined countermeasure component is electrically connected to the terminal of the reference component includes:
determining that the terminal of the determined countermeasure component is electrically connected to the terminal of the reference component when the terminal of the determined countermeasure component and the terminal of the reference component are connected to a same net.

4. The non-transitory computer-readable medium according to claim 1, which causes the computer to execute:
calculating, based on the design data, a distance measured along a form of a net connecting the terminal of the reference component and the terminal of the determined countermeasure component, and
determining that the countermeasure component is suitably mounted when a value of the distance is within a threshold set for each net.

5. A design check apparatus, comprising:
means for determining, based on design data, a countermeasure component provided in a certain range from a terminal of a reference component;
means for determining, based on the design data, whether a terminal of the determined countermeasure component is electrically connected to the terminal of the reference component; and
means for determining that the countermeasure component is suitably mounted when the terminal of the determined countermeasure component that is electrically connected to the terminal of the reference component is at least within the certain range.

6. A design check method executed by a computer, comprising:
determining, based on design data, a countermeasure component provided in a certain range from a terminal of a reference component;
determining, based on the design data, whether a terminal of the determined countermeasure component is electrically connected to the terminal of the reference component; and
determining that the countermeasure component is suitably mounted when the terminal of the determined countermeasure component that is electrically connected to the terminal of the reference component is at least within the certain range.

7. A method of checking a design, comprising:
extracting design data of a countermeasure component within a predetermined range from a terminal of a reference component; and
verifying a connection of a terminal of the countermeasure component extracted using at least the predetermined range.
